(19) United States
(12) Patent Application Publication
(10) Pub. No.: US 2008/0202871 A1
(43) Pub. Date: Aug. 28, 2008

(54) Pneumatic Braking System for a Commercial Vehicle

(75) Inventor: Denis Battistella, Paderno Dugnano (Milano) (IT)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Knorr-Bremse Sistemi Per Autoveicolo Commerical S.p.A., Arcore (Milano) (IT)

(21) Appl. No.: 11/995,857

(22) PCT Filed: Jul. 19, 2006
(86) PCT No.: PCT/IB06/52471

§ 371 Date: Jan. 16, 2008

(30) Foreign Application Priority Data
Jul. 20, 2005 (IT) TO2005A000498

(51) Int. Cl. B60T 13/38

(52) U.S. Cl. 188/170

(57) ABSTRACT

The system comprises
a brake cylinder with incorporated spring brake (1), associated with each wheel of at least one axle of the vehicle and having a first and a second inlet for pressurized air (1a, 1b), to actuate pneumatic braking when both inlets (1a, 1b) are under pressure, spring braking when the second inlet (1b) is discharged, and the release of spring braking when the second inlet (1b) is supplied once more with pressurized air;
a valve (6) for controlling the braking of a trailer;
a parking and emergency braking manual control valve (4),
a service braking control pedal valve (3); and
a control valve unit (7) including a relay valve (8; 108).

This invention regards a pneumatic system for braking a commercial motor vehicle.

More specifically, the invention relates to a pneumatic braking system for a tractor for pulling a trailer.

An object of the invention is to propose a pneumatic system which has a simplified control structure and highly reliable operation, in particular in relation to the parking and emergency braking.

This and other objects are achieved according to the invention by means of a pneumatic braking system, the main characteristics of which are defined in the attached Claim 1.

Further characteristics and advantages of the invention will appear from the detailed description which follows, which is provided purely by way of non-limiting example, with reference to the attached drawings, in which:

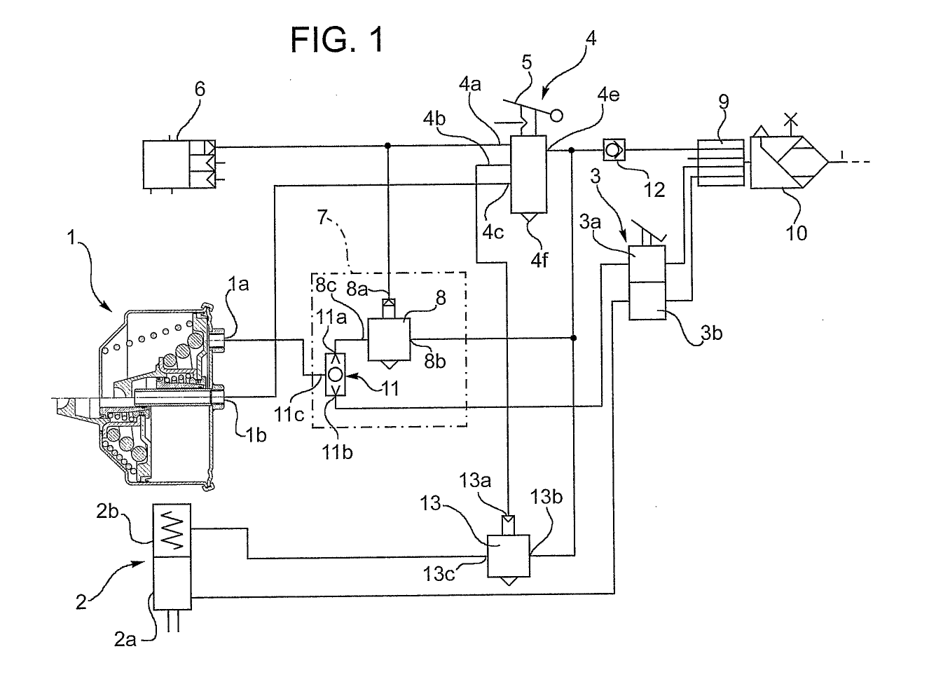

FIG. 1 is a plan of a pneumatic braking system according to the present invention;

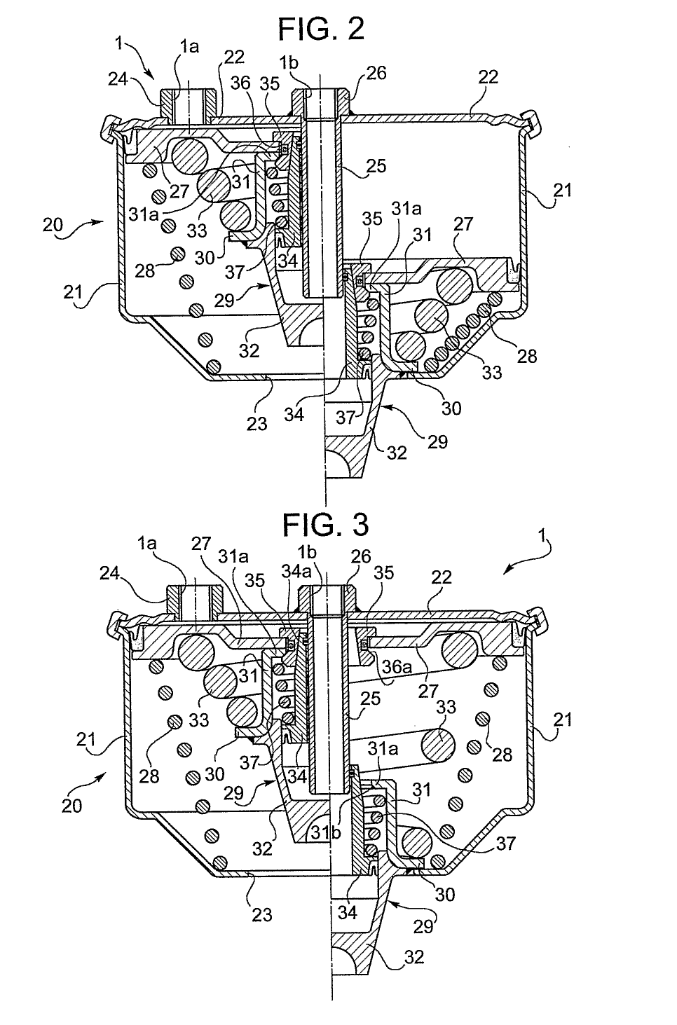

FIG. 2 is a sectional view of a brake cylinder with incorporated spring brake included in a braking system according to the invention, this brake cylinder being shown in two different working conditions;

FIG. 3 is a sectional view similar to the one in FIG. 2, and shows the brake cylinder with incorporated spring brake in two different working conditions,

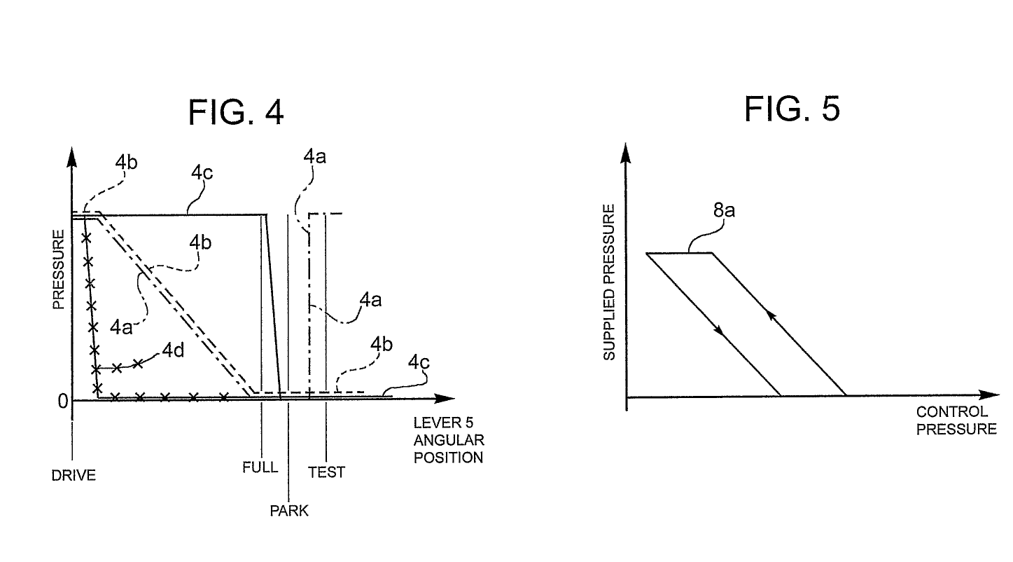

FIGS. 4 and 5 are diagrams which show characteristic curves of a parking and emergency braking manual control valve and of a relay valve included in a braking system according to the invention;

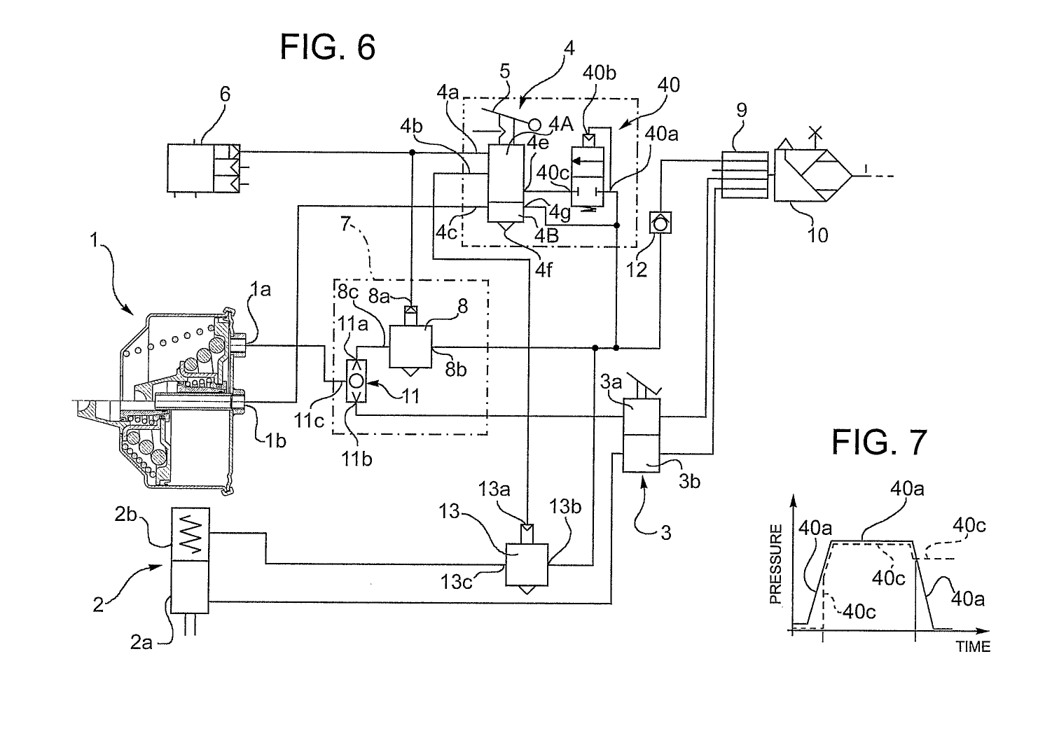

FIG. 6 is a plan of a variant of embodiment of a braking system according to the invention;

FIG. 7 is a diagram which shows the operating characteristic curve of a pressure stop valve associated with a parking and emergency braking manual control valve in several systems according to the invention;

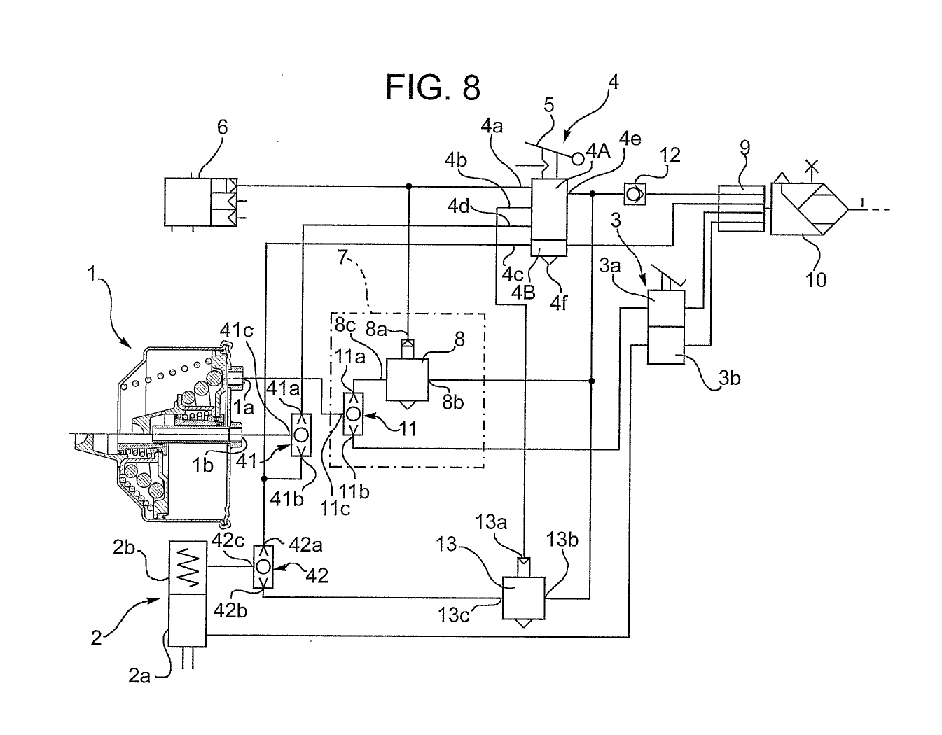

FIGS. 8, 9 and 10 are plans of further braking systems according to the present invention; and

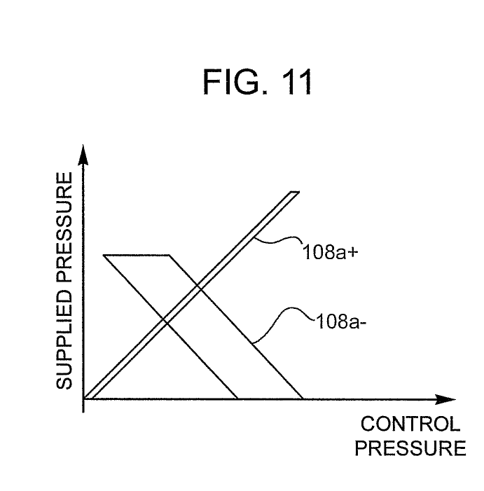

FIG. 11 is a diagram which shows an operating characteristic curve of a control valve unit included in a braking system according to the invention.

With reference to FIG. 1, in a first embodiment a pneumatic braking system according to the invention for a tractor suitable for pulling a trailer comprises a respective brake cylinder with incorporated spring brake for each front axle wheel, indicated by 1 as a whole. One (non-limiting) form of embodiment of this brake cylinder will be described in detail below with reference to FIGS. 2 and 3.

The system comprises a respective spring braking bielement, indicated as 2 in FIG. 1, for each wheel of the rear axle(s) of the tractor. Such braking spring bielements are well known in the art and comprise a service braking element 2a, and a spring braking element 2b for parking and emergency braking.

The braking system in FIG. 1 comprises a service braking control pedal valve 3, of a type known per se. In the embodiment illustrated this pedal valve 3 has two sections, 3a and 3b, for controlling braking of the front axle wheel and of the wheels of the rear axle(s).

The system also comprises a parking and emergency braking manual control valve 4. This valve 4 has a manual actuating element 5, suitable for completing a working stroke (typically an angular stroke) in which it is capable of assuming a plurality of positions which will be described below, in order to actuate various corresponding functions.

The parking and emergency braking manual control valve 4 has a first outlet 4a connected to a trailer braking control valve 6, of a type known per se. This first outlet 4a of the valve 4 is also connected to a control valve unit indicated in its entirety by 7.

In the embodiment illustrated as an example in FIG. 1, this control valve unit 7 comprises a relay valve 8 having a negative control inlet 8a connected to the outlet 4a of the parking and emergency braking control valve 4, and a supply inlet 8b, connected to pressurized air supply devices installed on board the tractor and known per se. With regard to these devices, FIG. 1 illustrates only a reservoir protection valve unit 9 and a pressure and drying adjustment unit 10.

The control valve unit 7 also comprises a double check valve 11 which has an inlet 11a connected to the outlet 8c of the relay valve 8, a second inlet 11b connected to the outlet of the first section 3a of the service braking control valve 3, and an outlet 11c connected to a first inlet 1a of the brake cylinder with incorporated spring brake 1 of each front axle wheel. Each of these brake cylinders 1 also has a second inlet 1b connected to a further outlet 4c of the parking and emergency braking manual control valve 4. The latter has an inlet 4e connected to the pressurized air supply devices through a one-way valve 12, a discharge opening 4f, and an outlet 4b connected to the positive control inlet 13a of a further relay valve 13.

The relay valve 13 has a supply inlet 13b connected to the pressurized air supply devices through the one-way valve 12, and an outlet 13c connected to the spring braking elements 2b of the braking bielements 2 associated with the wheels of the rear axle(s). The service braking elements 2a of these braking bielements are, on the other hand, connected to the outlet of the second section 3b of the service braking control pedal valve 3.

With reference to FIGS. 2 and 3, each brake cylinder with incorporated spring brake 1 comprises a rigid casing 20 including essentially a cup body 21 on the edge of which a cover 22 is coupled tight. A central opening 23 is realized in the bottom wall of the cup body 21. Fixed in the first opening of the cover 22 is an inlet fitting 24 which constitutes the inlet la of the brake cylinder. Fixed in a further, central, opening of the cover 22 is a tube 25 which extends axially in the casing 20. Connected to this tube 25 is a fitting 26 which constitutes the second inlet 1b of the brake cylinder 1.

A main piston 27 is fitted movably in the casing 20, and in particular in the cup body 21. A spring 28 is arranged between the bottom wall of the cup body 21 and the main piston 27, and tends to push the latter in the direction of the cover 22.

Fitted translatably below the main piston 27 in the body 21 is a hollow-shaped body 29 which has an external intermediate radial flange 30. In the embodiment illustrated as an example, the body 29 is formed by a top tubular element 31 and a bottom cup element 32, welded together.

A helical spring 33 is placed between the main piston 27 and the flange 30 of the body 29 and tends to push the latter downwards.

A tubular piston 34 is mounted slidably and tight around the tube 25. The bottom end of this piston is mounted slidably and tight in the top part of the cup element 32. The top end of piston 34 has a truncated cone external lateral surface 34a, converging upwards, capable of engaging with and, in particular, of wedging into a coupling ring 35.

The ring 35 is realized in such a way that it is radially dilatable and contractible.

The main piston 27 has a central opening coaxial with the tube 25, and the coupling ring 35 has a peripheral annular seat 36 in the manner of a groove, suitable for receiving the edge of the piston 27 surrounding said opening, as well as a corresponding part of top edge 31a of the tubular element 31 of the shaped body 29. This part of edge 31a of the tubular element 31 is turned radially towards the axis of the tube 25, and its section has an inclined terminal bevel indicated by 31b in the right-hand side of FIG. 3. Correspondingly, the cross section of the bottom part of the seat 36 of coupling ring 35 has an inclined side, indicated by 36a in the right-hand part of FIG. 3.

A helical spring 37 is placed between the top edge 31a of the shaped body 29 and the axially lower part of the internal piston 34.

In a manner not shown, the shaped element 29 is coupled to braking elements (not illustrated) associated with a wheel of the tractor's front axle. As will appear more clearly below, the shaped body 29 is mobile between a rest position, shown in the left-hand parts of FIGS. 2 and 3, in which it disables braking of the corresponding wheel, and a work position, shown in the right-hand parts of FIGS. 2 and 3, in which the braking of this wheel is determined.

The brake cylinder 1 described above works essentially in the following way.

### Drive Conditions

When the vehicle is in the normal drive condition, there is no pressurized air at the inlet 1a, while there is pressurized air at the inlet fitting 1b on the other hand. In this condition, the device assumes the condition shown in the left-hand parts of FIGS. 2 and 3: the tubular piston 34 is pushed upwards pneumatically and its top end part wedges into the coupling ring 35 which is in a radially expanded condition and renders the top piston 27 and the shaped body 29 integral with each other. The assembly formed by this piston 27 and the body 29 is maintained in the illustrated position as an effect of the action of the spring 28. The intermediate spring 33 is compressed.

### Service Braking

Pressurized air is supplied at the inlet 1a to activate service braking. Pressurized air is also supplied to inlet 1b. During service braking the device assumes the configuration displayed in the right-hand part of FIG. 2: the pressure exerted on the top face of the piston 27 leads to the assembly formed by this piston, by the shaped body 29, by the spring 33 between them, by the tubular piston 34 and by the spring 37 moving down. The displacement of the shaped body 29 determines a corresponding activation of the braking devices associated with the corresponding wheel.

### Parking Braking

The passage from the drive condition to the parking braking condition takes place by discharging the pressure at inlet 1b. The presence or absence of pressure at inlet 1a is irrelevant. The device 1 moves to the condition shown in the right-hand part of FIG. 3: the discharge of pressure at inlet 1b permits the spring 37 to press the tubular piston 34 downwards, the top end of which then disengages from the coupling ring 35; the intermediate spring 33 can then press the shaped body 29 downwards, the top edge 31a of which manages to release itself from the ring 35 which is radially yielding with compression. The ring 35 remains “hooked” to the main piston 27, while the assembly formed by the body 29, by the tubular piston 34 and by the spring 37 interposed between them descends downwards under the action of the spring 33 and activates parking braking.

### Parking Braking Release

To release parking braking it is first of all necessary to apply pressurized air to the inlet 1a: the top piston 27 then descends against the action of the spring 28, bringing the coupling ring 35 with it. When the piston 27 reaches the position shown in the right-hand part of FIG. 2, the ring 35 re-engages with the truncated cone part of the tubular piston 34 and couples again under the top edge 31a of the element 31 of the shaped body 29. This body 29 finds itself axially integral once again with the main piston 27. At this point, the inlet 1b is pressurized and the pressure is discharged at inlet 1a and: the main piston 27 returns upwards under the thrust of the spring 28 and the assembly returns to the condition illustrated in the left-hand parts of FIGS. 2 and 3.

The pneumatic braking system described above with reference to FIG. 1, works essentially as follows.

### Drive Condition

In this condition, the outlets of the service braking control pedal valve 3 are not pressurized. Lever 5 of the parking and emergency braking manual control valve 4 is arranged in the “DRIVE” position (FIG. 4) and all the outlets 4a-4c of this valve 4 are pressurized.

As a consequence, outlet 8c of relay valve 8 is not pressurized while the outlet of relay valve 13 is. The inlet 1a of front brake cylinders 1 is not pressurized and inlet 1b is pressurized, while the spring braking elements 2b of the rear braking bielements 2 are pressurized and the service braking elements 2a are not pressurized.

In the drive condition, the action of pedal valve 3 makes it possible to modulate service braking by means of the transmission of corresponding modulated pressures to the valve unit 7 and to the rear service braking elements 2a.

### Secondary Emergency Braking

In the event of failure of the main or service braking, it is possible to realize secondary emergency braking by means of the manual valve 4, with modulated braking pressure. For this purpose, lever 5 is displaced manually over a continuous range of positions which extends substantially between the drive position and the angular position indicated by “FULL” in FIG. 4.

In these conditions, the outlets of the service braking control pedal valve 3 are not pressurized. Instead, outlet 4c of manual valve 4 is pressurized, while outlets 4 and 4b are pressurized to a variable extent depending on the angular position of lever 5. As a consequence, there is a modulated, or variable, pressure at outlet 8c of relay valve 8, as is also the case at outlet 13c of relay valve 13.

Pedal valve 3 can also, if necessary, cause a modulation in parallel of the braking force if actuated, and in this case the presence of the double check valve 11 causes the greater pressure to be applied to the brake cylinders 1 of the front axle.

### Parking Braking

Lever 5 of manual valve 4 is placed in the “PARK” position (graph in FIG. 4). The non-pressurized condition of all the outlets 4a-4c of valve 4 corresponds to this position of lever 5. The outlets of the service braking control pedal valve 3 are not pressurized either. As a consequence, outlet 8c of relay valve 8 is pressurized, while outlet 13c of the relay valve 13 is not pressurized. There is pressure at the inlet 1a of the front brake cylinders 1, while the inlets 1b of these brake cylinders 1 are discharged. The front wheels are braked under the action of the springs 33 of the brake cylinders 1, and the rear wheels are braked by the spring braking elements 2b of the braking bielements 2.

### Test Condition

Lever 5 of the manual valve 4 can be placed in another position, indicated as “TEST” in FIG. 4, to check that the vehicle is able to remain stopped exclusively by way of application of the spring parking brakes. When the lever 5 is in the TEST position, outlet 4a of valve 4 is pressurized, while outlets 4b and 4c are not pressurized. As a consequence, inlets 1a and 1b of the front brake cylinders 1 are not pressurized, and in the same way the spring braking elements 2b of the rear braking bielements 2 are not pressurized either. The pressure at the outlet 4a of manual valve 4 makes it possible to realize the release of the service braking of any trailer by means of the valve 6. The test function is for checking that the spring parking brakes are sufficient to ensure that the vehicle remains stopped when the reservoirs are empty.

FIG. 5 qualitatively illustrates the characteristic pressure curve supplied as a function of the control pressure for the control valve unit 7 including the relay valve 8.

FIG. 6 shows a variant of embodiment of the braking system described above in relation to FIG. 1. The same reference numbers previously used have been attributed again in FIG. 6 to the parts and elements already described.

The system according to FIG. 6 differs essentially in the following aspects from the system in FIG. 1. The parking and emergency parking manual control valve 4 has two sections 4A and 4B. The first section 4A has the outlets 4a and 4b already described above, and its supply inlet 4e is coupled to pressurized air supply devices through a stop valve 40. This valve is of the two-way two-position type, normally closed, with an inlet 40a connected to pressurized air supply devices through the one-way valve 12, and with the outlet coupled to the inlet 4e of the manual valve 4. The stop valve 40 has a control inlet 40b connected to the inlet 40a. In this way valve 40 is piloted by the pressure of the air supplied by the pressurized air supply devices. When the pressure at its piloting inlet 40b is greater and respectively lower than a preset value, the valve 40 permits and, respectively, impedes the connection of the first section 4A of the manual valve 40 to the pressurized air supply.

The second section 4B of manual valve 4 has the outlet 4c already discussed above, and also has its own supply inlet 4g coupled directly to the one-way valve 12 and therefore to the pressurized air supply.

The stop valve 40 associated with the manual valve 4 makes it possible to delay the release of service braking when the vehicle starts with the pressurized air reservoirs completely or almost completely empty. If the vehicle reservoirs are substantially empty and lever 5 of manual valve 4 is placed in the “drive” position and the vehicle engine is started, the on-board compressor(s) start(s) up and the pressure of the air compressed in this way starts to rise, however slowly. In this condition, there is generally not a sufficient pressure at inlets 1a of the front brake cylinders 1 to permit release of parking braking. In this case the stop valve 40 acts in such a way that the outlets 4a and 4b of the first section 4A of manual valve 4 and the corresponding inlet of the braking control valve 6 of any trailer are not pressurized. In this condition the air pressure at the inlet 8b of relay valve 8 rises slowly, and this pressure is found again at outlet 8c of this valve as the control inlet 8a of said relay valve continues to remain unpressurized as an effect of the intervention of the stop valve 40.

FIG. 7 shows the characteristic pressure/time curve of the stop valve 40.

FIG. 8 shows a further variant of embodiment of a pneumatic braking system according to the invention. The same reference numbers previously used have been attributed again in this Figure to the parts and elements already described.

Compared with the system in FIG. 1, the system according to FIG. 8 differs essentially in the following aspects.

The parking and emergency braking manual control valve 4 has two sections 4A and 4B, the inlets of which are coupled separately to the pressurized air supply.

The first section 4A has the outlets 4a and 4b connected as already indicated above, and a further outlet indicated by 4d. This outlet is connected to a first inlet 41a of a double check valve 41, which has a second inlet 41b connected to the outlet 4c of the second section 4B of the manual valve 4. The outlet 41c of the valve 41 is connected to the inlets 1b of the brake cylinders 1 of the front axle.

The system in FIG. 8 also comprises a third double check valve 42, with a first inlet 42a connected to the outlet 4c of the manual valve 4, a second inlet 42b connected to the outlet 13c of the relay valve 13, and an outlet 42c connected to the spring braking elements 2b of the rear wheels.

The characteristic curve of the pressure/angular position of the lever of manual valve 4 for the braking system according to FIG. 8 is substantially the one already described with reference to FIG. 4. This Figure also includes a line indicated by 4d which represents the pattern of the pressure at additional outlet 4d of the first section 4A of the manual valve 4 of FIG. 8. The characteristic pressure supplied as a function of the control pressure of the relay valve 8 of FIG. 8 corresponds to the graph in FIG. 5.

With the system according to FIG. 8, it is possible in any case to release parking braking if the compressed air reservoirs of the vehicle are empty, by applying the service braking for a brief period of time by means of the pedal valve 3.

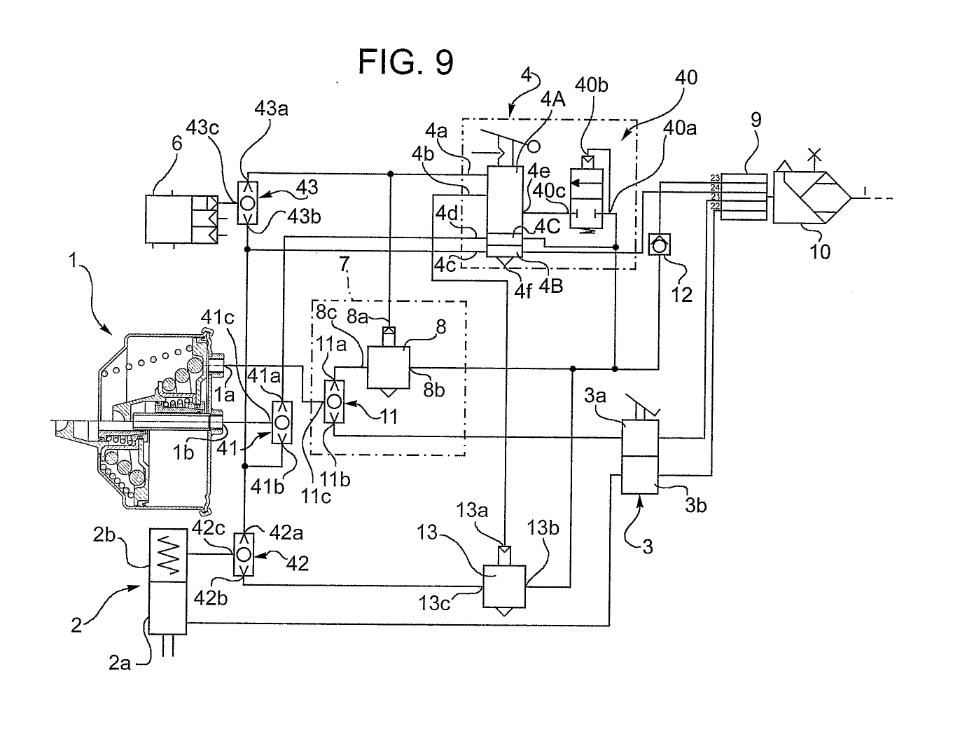

FIG. 9 illustrates a further embodiment of a braking system according to the invention. The same reference numbers previously used have been attributed once again in this Figure to the parts and elements already described.

The system according to FIG. 9 is substantially a hybrid of the two systems illustrated in FIGS. 6 and 8: as in the former, a stop valve 40 is associated with the manual valve 4, and as in the latter the double check valves 41 and 42 are envisaged.

Moreover, in the system according to FIG. 9 the parking and emergency braking manual control valve 4 has a third section 4C whose inlet is connected directly to the pressurized air supply by means of the one-way valve 12, while its outlet 4d is connected to the double check valve 41.

A further double check valve 43 can be observed in the system illustrated in FIG. 9, with a first inlet 43a connected to the outlet 4a of the valve 4, a second inlet 43b connected to the outlet 4c of said manual valve 4 and the outlet 43c connected to the trailer braking control valve 6. This double check valve 43 is for preventing any trailer from remaining braked when emergency braking is released.

The manual valve 4 of the system according to FIG. 9 has the operating characteristic curve shown in FIG. 4, the relay valve 8 has the operating characteristic curve shown in FIG. 5, and the stop valve 40 has the characteristic curve shown in FIG. 7.

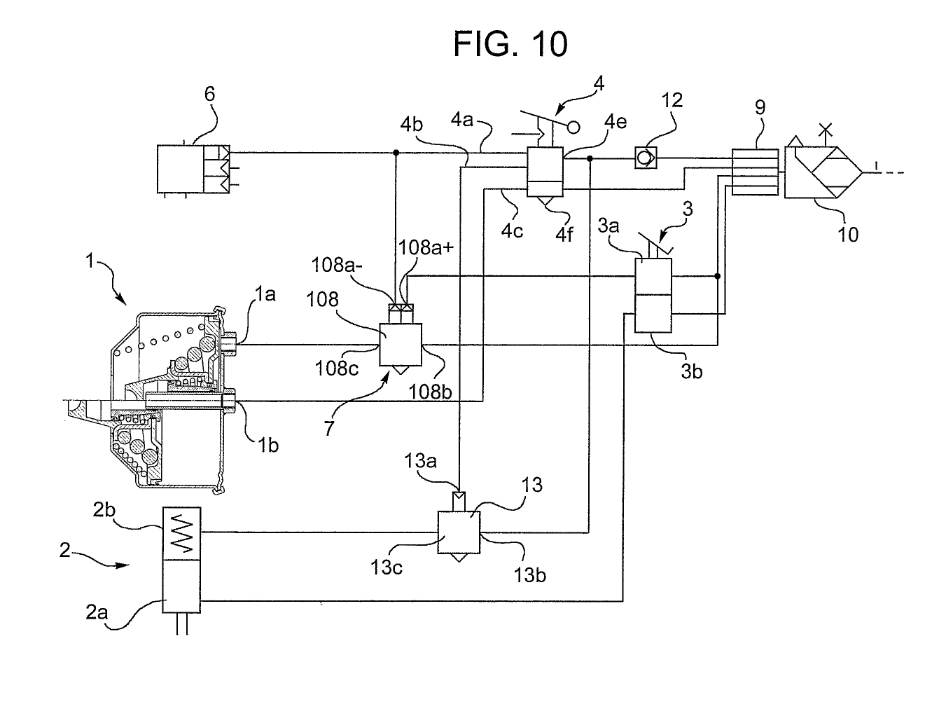

FIG. 10 shows a further variant of embodiment of a pneumatic braking system according to the invention. The same reference numbers previously used have been attributed once again in this Figure to the parts and elements already described.

Compared with the braking system illustrated in FIG. 1, the system according to FIG. 10 differs essentially because of the fact that the control valve unit 7 comprises a relay valve 108 with a negative control inlet 108a− connected to the outlet 4a of the manual valve 4, and a positive control inlet 108a+ connected to the outlet of section 3a of the service braking control pedal valve 3. The relay valve 108 has a supply inlet 108b connected to the pressurized air supply, and an outlet 108c connected to the outlets of the brake cylinders 1 associated with the wheels of the front axle.

The operating characteristic curves of the relay valve 108 are illustrated qualitatively in the diagram in FIG. 11.

The system according to FIG. 10 works in the same way as the system according to FIG. 1.

Naturally, without prejudice to the principle of the invention, the embodiments and the constructional details may vary considerably from what has been described and illustrated purely by way of a non-limiting example, without thereby departing from the scope of the invention as defined in the accompanying claims.

1. Pneumatic system for braking a commercial vehicle, in particular a tractor suitable for pulling a trailer, the system including
a brake cylinder with incorporated spring brake (1), associated with each wheel of at least one axle of the vehicle and having a first and a second inlet for pressurized air (1a, 1b)
said brake cylinder (1) being suitable for actuating pneumatic braking when both of said inlets (1a, 1b) are under pressure, spring braking when said second inlet (1b) is discharged, and the release of spring braking when pressurized air is supplied again to the second inlet (1b);
a valve (6) for controlling the braking of any trailer connected to the vehicle;
a parking and emergency braking manual control valve (4), having at least one inlet (4e) connected to pressurized air supply means (9, 10) and a first outlet (4a) and a further outlet (4c) connected to the trailer braking control valve (6) and, respectively, to the second inlet (1b) of the abovementioned brake cylinder (1) associated with each wheel of said at least one axle;
a service braking control pedal valve (3), having at least one inlet connected to the pressurized air supply means (9, 10), and at least one outlet; and
a control valve unit (7) including a relay valve (8; 108) and having a control inlet (8a; 108a−) connected to said first outlet (4a) of the parking and emergency braking manual control valve (4), a further inlet (8b; 108b) connected to the pressurized air supply means (9, 10) and an outlet (8c; 108c) connected to the abovementioned inlet (1a) of the brake cylinder (1) associated with each wheel of said at least one axle;
the parking and emergency braking manual control valve (4) being realized in such a way that its manual actuating element (5) is suitable for completing a working stroke in which it is capable of assuming:
a drive position, in which its abovementioned outlets (4a, 4c) are both pressurized at a predetermined value;
a continuous range of positions, for emergency braking, in which its first outlet (4a) is at a variable pressure depending on the position of said manual element (5), and its abovementioned further outlet (4c) is pressurized at a predetermined value;
a parking position, in which its abovementioned outlets (4a, 4c) are both discharged, and
a test position, in which its first outlet (4a) is pressurized, and its abovementioned further outlet (4c) is discharged.

2. Pneumatic braking system according to claim 1, in which the brake cylinder with incorporated spring brake (1), associated with each wheel of said at least one axle of the vehicle and including
a rigid casing (20) with a first inlet (1a) for air under pressure suitable for provoking a displacement of a main piston (27) movable tight in the casing (20) against the action of (first) elastic means (28),
a shaped body (29), mobile in the region of the casing (20) opposite the first inlet (1a) with respect to the main piston (27), between one rest position and a work position in which it disables and respectively determines the braking of the corresponding wheel, a spring (33), interposed between the main piston (27) and said shaped body (29) and tending to push this body (29) towards the work position, and
a releasable interlock device (34-37), inside the casing (20) and suitable, when a pneumatic control pressure is supplied and respectively discharged at a second inlet (1b) of the casing (20), for rendering the shaped body (29) integral with the main piston (27), against the action of said spring (33), to permit service braking as an effect of the pressure supplied to said first inlet (1a) and, respectively, for releasing the shaped body (29) of the main piston (27) in order to permit parking braking under the action of said spring (33).

3. Pneumatic braking system according to claim 1, also comprising
a respective spring braking bielement (2) associated with each wheel of at least one other axle of the vehicle and including a service braking element (2a) connected to the outlet of a further section of the service braking control valve (3), and a spring braking element (2b) for parking and emergency braking; and
a further relay valve (13) with a positive control inlet (13a) connected to a second outlet (4b) of the parking and emergency braking manual control valve (4), a supply inlet (13b) connected to the abovementioned pressurized air supply means (9, 10) and an outlet (13c) connected to the spring braking elements (2b) of the braking bielements (2) of the wheels of said at least one other axle.

4. Pneumatic braking system according to claim 1, in which said control valve unit (7) comprises
a relay valve (8) with a negative control inlet (8a) connected to the abovementioned first outlet (4a) of the parking and emergency braking control valve (4), and with a supply inlet (8b) connected to the pressurized air supply means (9, 10), and
a double check valve (11) with a first and a second inlet (11a, 11b) connected to the outlet of said relay valve (8) and, respectively, to the outlet of the service braking control valve (3), and the outlet (11c) connected to the first inlet (1a) of the abovementioned brake cylinders (1) of the wheels of said at least one axle.

5. Pneumatic braking system according to claim 3, in which (FIG. 8) the parking and emergency braking manual control valve (4) has
a first section (4A) with a first and a second outlet (4a, 4b) connected to the trailer braking control valve (6) and, respectively, to the control inlet (13a) of said further relay valve (13); said manual valve (4) having a further or third outlet (4d) connected to the second inlet (1b) of the abovementioned brake cylinders (1) associated with the wheels of said at least one axle; and
a second section (4B) having a respective outlet (4c);
and provided in which are
a second double check valve (41) with a first and a second inlet (41a, 41b) connected to said further or third outlet (4d) and, respectively, to the outlet (4c) of the second section (4B) of the parking and emergency braking manual control valve (4), and to the outlet (41c) connected to the second inlet (1b) of the abovementioned brake cylinders (1) associated with the wheels of said at least one axle, and
a third double check valve (42) with a first and a second inlet (42a, 42b) connected to the outlet (4c) of the second section (4B) of the parking and emergency braking control valve (4) and, respectively, to the outlet (13c) of said further relay valve (13), and with the outlet (42c) connected to the spring braking elements (2b) associated with the rear axle wheels.

6. Pneumatic braking system according to claim 3, in which (FIGS. 6 and 9) the abovementioned parking and emergency braking manual control valve (4) has a first section (4A) having a first and a second outlet (4a, 4b) connected to the trailer braking control valve (6) and, respectively, to the control inlet (13a) of the abovementioned further relay valve (13), and in which said manual valve (4) is associated to a pressure stop valve (40) piloted by the pressure of the air supplied by the abovementioned pressurized air supply means (9, 10) and suitable, when its piloting pressure is greater and respectively lower than a preset value, in order to permit and respectively prevent the connection of the first section (4A) of said manual valve (4) with the supply means (9, 10).

7. Pneumatic braking system according to claim 5, comprising (FIG. 9) a fourth double check valve (43) with a first and second inlet (43a, 43b) connected to the first outlet (4a) of the first section (4A) and respectively to the outlet (4c) of the second section (4B) of the parking and emergency braking manual control valve (4), and the outlet (43c) connected to the trailer braking control valve (6), in such a way, in operation, as to prevent any trailer from remaining braked during emergency brake release.

8. Pneumatic braking system according to claim 2, in which (FIG. 10) said control valve unit (7) comprises a relay valve (108) with a negative control inlet (108a−) connected to the abovementioned first outlet (4a) of the parking and emergency braking manual control valve (4), a positive control inlet (108a+) connected to the service braking control pedal valve (3), a supply inlet (108b) connected to said pressurized air supply means (9, 10), and an outlet (108c) connected to the first inlet (1a) of the abovementioned brake cylinders (1) associated with the wheels of said at least one axle.

9. Pneumatic system for braking a commercial vehicle, substantially according to what has been described and illustrated, and for the purposes specified.
